(19) United States
(12) Patent Application Publication
(10) Pub. No.: US 2019/0141048 A1
(43) Pub. Date: May 9, 2019

(54) BLOCKCHAIN IDENTIFICATION SYSTEM

(71) Applicant: NXM Technologies Inc., Toronto (CA)

(72) Inventors: Jay Fallah, Toronto (CA); Scott Rankine, Toronto (CA); Josef Zankowicz, Toronto (CA)

(21) Appl. No.: 16/183,254

(22) Filed: Nov. 7, 2018

Related U.S. Application Data
(60) Provisional application No. 62/583,231, filed on Nov. 8, 2017.

(51) Int. Cl. H04L 29/06; H04L 29/08; H04L 9/08; H04L 9/06; H04L 12/40

(52) U.S. Cl. CPC H04L 63/102; H04L 63/0876; H04L 67/104; H04L 9/0861; H04L 9/0894; H04L 2012/40273; H04L 9/0637; H04L 12/40; H04L 2209/38; H04L 2012/40215; H04L 9/0643

(57) ABSTRACT

A computing device comprises a processor module executing software to conduct a transaction, a networking module enabling connections to a peer-to-peer network, and an ASIC coupled to the processor module and the networking module. The ASIC comprises a blockchain server, an encryption module, and a memory storing a distributed ledger. The ASIC performs a calculation of a memory block within a predetermined minimum time and a predetermined maximum time. The block is stored in the distributed ledger by the blockchain server and is transmitted to the peer-to-peer network by the networking module.

### CROSS REFERENCE TO RELATED APPLICATIONS

This application claims priority to U.S. Provisional Application No. 62/583,231, filed Nov. 8, 2017, which is hereby incorporated by reference herein in its entirety

### BACKGROUND OF THE INVENTION

### Field of the Invention

The present invention relates to electronically verifying the identify of devices and people and more particularly to using blockchain technology to store and manage identify information.

### Description of Related Art

There are many applications where it is required to confirm the identity of a person. These include conducting banking transactions, receiving government services, checking into a flight, crossing a national border, and many more. Most people own and carry one or several personal digital devices that they use to conduct or may aid in these transactions. This is typically done using explicit authentication such as requiring a username and password, a pass key, drawing a pattern, requiring biometric information, or other means as known in the art. It may also be done using implicit authentication that monitors how or where the device is being used and determining if it matches the user's typical usage pattern.

Recently, there has also been a great increase in the number of smart, networked devices referred to as IoT (Internet of Things) devices. These devices interface with user mobile devices, computers, and infrastructure. Many applications would benefit from having confidence or require confidence as to the identity of the IoT devices that they are in communication with.

Some effort can be made to verify the identity of a device based on information such as browser used, location and other factors but there is presently no way to ensure that this information is accurate and that it corresponds to a particular device as opposed to a similar device or a device that is spoofing the factors being evaluated. There are several challenges related to verifying identities on resource constrained, mobile, IoT, or intermittently online devices. One is that device identity cannot be verified by the device itself and may have to be checked against a central database which may be difficult to do in a timely manner due to network connectivity constraints. Furthermore, many resource constrained devices do not have sufficient computing power to perform required secure encryption calculations in a timely manner. There exists a need for systems and methods to verify the identity of devices without the need for centralized databases and servers that may be disconnected from resource constrained, mobile, IoT or intermittently online devices. As well, it must be feasible for any calculations that must be performed by the user device to be done in a timely manner within the computing constraints of the device.

Once the identity of a device has been verified in a trustworthy manner this information can be used as a factor in verifying the identity of a user to some degree of confidence. The methods used can be similar to those of verifying the device identity with similar drawbacks and constraints as outlined above.

Other aspects and features of the present invention will become apparent to those ordinarily skilled in the art upon review of the following description of specific embodiments of the invention.

### BRIEF SUMMARY OF THE INVENTION

Embodiments of the invention according to a first major aspect include a computing device comprising a processor module executing software to conduct a transaction, a networking module enabling connections to a peer-to-peer network, and an ASIC coupled to the processor module and the networking module. The ASIC comprises a blockchain server, an encryption module, and a memory storing a distributed ledger. The ASIC performs a calculation of a memory block within a predetermined minimum time and a predetermined maximum time. The block is stored in the distributed ledger by the blockchain server and is transmitted to the peer-to-peer network by the networking module.

Further embodiments comprise an OBD interface coupled to the processor module. The OBD interface is coupled to a vehicle OBD bus and receives operating information from the vehicle OBD bus.

In other embodiments, the ASIC further comprises a secure memory block. The encryption module calculates a public key and a private key pair and the private key is stored in the secure memory block.

In other embodiments, the ASIC calculates a concrete identity of the computing device based on the public key and a unique value. The concrete identity is stored in the distributed ledger.

In further embodiments, a smart contract is stored in the distributed ledger. The smart contract comprises data and software to execute a peer-to-peer contract between the computing device and an external device. The computing device and the external device are coupled through the networking module.

In other embodiments, the smart contract comprises identifying data of a user associated with the computing device and the software performs an authentication to allow a third person to access the identifying data.

In another embodiment, the calculation comprises generating a nonce, calculating a hash over the nonce and memory block data, and determining if the hash meets a requirement to be added to the blockchain.

Other aspects and features of the present invention will become apparent to those ordinarily skilled in the art upon review of the following description of specific embodiments of the invention in conjunction with the accompanying figures.

### DETAILED DESCRIPTION OF THE INVENTION

The present invention is directed to systems and methods for verifying the identity of devices and users. More particularly it utilizes blockchain technology and ASICs (application specific integrated circuits) to implement authentication protocols on resource constrained, mobile, IoT or intermittently online devices.

In embodiments of the invention, blockchain technology is used to implement a distributed ledger that is used to store, verify, and retrieve identity information and smart contracts for devices and individuals. The blockchain is a reverse linked list where each block includes the hash of a pointer to the previous block. The first block in the chain is referred to as a Genesis block and has an address of zero. Each block includes a data field and a nonce. The nonce is a random number of fixed length that when hashed with the data field, yields a value with a predefined number of leading zeros. The larger the number of leading zeros required, the more difficult it is to find a nonce that fulfils the requirement. Blocks can only be added to the end of the chain, they cannot be updated or deleted as any changes to existing blocks will break the hash used as a reverse pointer in the next block in the chain. The data stored in each block may be data, may also be actions in the form of software that is stored in the blocks, and may be a combination of the two. In this way, data and actions may be combined and actions automatically taken when predefined conditions are met. This mechanism may be used to implement a peer-to-peer relationship between node devices.

The blockchain is publicly accessible and is stored on the Internet. Nodes in the system are networked together in a peer-to-peer network with copies of the blockchain stored in nodes. Changes to the blockchain require a consensus among nodes that have copies of the blockchain. The multiple copies of the blockchain allow the system to ensure the veracity of the contents of the ledger as it is virtually impossible for an attacker to modify a required number of the blockchain copies to form a consensus. Specific embodiments of the invention will require that a predetermined number of the total network nodes have to be consistent for the block contents to be trusted. Should a device be compromised and its copy of the blockchain modified, it will likely be the only non-consistent copy and may be detected and isolated.

In order to add new blocks to the blockchain, the nodes of the system must be able to determine a new nonce for the block, calculate a hash over the nonce and data, and see if it produced a result with the required number of leading zeros. If the result does not have the required number of leading zeros a new nonce is chosen and the calculation repeated until a result with the required number of leading zeros is found. Nonces are typically generated at random and in most cases the hash calculations must be performed many times before a new nonce is found and a new block can be added to the chain. In embodiments of the invention an ASIC device or chipset is added to devices to allow IoT, mobile, and similar devices to perform these calculations sufficiently fast to implement a working system. The use of an ASIC also produces a known amount of time for calculations. Using an ASIC to perform the calculations within a known amount of time allows for the system to exclude calculation results that are completed too fast or too slow which adds an additional level of security. The use of an ASIC also makes the calculation time dependent on the ASIC itself, not on the capabilities, speed and memory space of another CPU in the system, which can vary greatly. An additional feature of the ASIC is that it implements a distributed ledger server. Each ASIC enabled device shares the same ledger.

Individual nodes and the blockchain implement a SSID (self-sovereign identity) platform where the device nodes may act autonomously and include rules governing the workflow and approvals needed to update data without storing identity data. Data may be stored on the device it relates to but when it is necessary to verify the veracity of the data, the data itself does not have to be transmitted. Each node creates a private and public key. The private key is stored securely in the node. The public key is used to create a hash that is used as the public identity of the device. This public identity is referred to as a concrete identity. The concrete identity is used to identify the device and allow it to interact with other device nodes in the system as an IoT device without having to authenticate with a central authority, server, or network. Data stored on the blockchain includes smart contracts that include the rights and roles of devices and defines how devices interact with each other. Private or personal data is not required to be stored on the blockchain. Data transfer is encrypted and transmitted in a peer-to-peer network between device nodes which may be trusted or untrusted peers. By implementing SSID, the devices may act independently while providing a useful IoT function. The blockchain defines the roles of the devices in the network which allows a group of devices to independently work together. The blockchain blocks may contain smart contract software which is conditionally executed automatically for device to device transactions.

Embodiments of the invention can be used in almost any type of networked device including vehicles. One example of a vehicle application comprises a hardware dongle that plugs into the OBD (On Board Diagnostics) port of a vehicle. Dongles may be factory installed, installed by a dealer, or by third party mechanics. Dongles may have an open hardware design and be available from a number of manufacturers and sources. Dongles may also contain a SIM card or embedded SIM (eSIM) card to enable cellular communications. New dongles contain a memory that is initially blank and may come with a unique bar code, serial number, or other identifier. As part of the initialization sequence, the dongle may self-configure itself and create a public-private key pair. The private key is never advertised and may be stored in a secure memory area of the ASIC. The public key may be calculated from the hash of the public key. The device may also have a unique identifier such as a serial number or bar code. The concrete identity is placed on the blockchain if there is no existing concrete identity already associated with the device's unique identifier on the blockchain. This concrete identity is then placed on the blockchain and after consensus is achieved with the other nodes in the blockchain, the device's identity becomes enshrined allowing others to discover and verify its existence. The dongle can monitor a variety of sensors in the vehicle as well as operating conditions and parameters. Networking capabilities of the dongle allow it to form or join a peer-to-peer network and communicate with other vehicles in proximity. Other network nodes may be other vehicles or locational beacons that may be placed at key points along the routes taken by the dongle enabled vehicle such as entering and leaving highways, loading docks, secure locations and others.

Through the use of a peer-to-peer network, embodiments of the invention allow multiple

IoT devices to form a peer-to-peer mesh network based on a distributed ledger of trusted devices stored on the blockchain. Each of the IoT devices includes a distributed ledger sever which shares the same ledger and maintains an index of all the blockchains. In order to access a particular device a predefined number of the other devices must grant permission and form a consensus. Communications between the devices in the group is secured using public/private key encryption.

Embodiments of the invention may also be used to verify the identity of a person interacting with a computer or machine to within a predetermined level of confidence. Personal identity can be viewed as comprising the identification of the person and the action that they are authorized to perform. For example, at a national border a passport identifies who you are and that you are authorized to travel. A driver's license identifies who you are and that you are authorized to drive a class of vehicle until the expiration of the license. Devices are also nodes in a peer-to-peer network and the concrete identity is assured by the blockchain. This can be leveraged to determine the identity of a person and be used to grant or deny permission to use or interact with these devices.

In the case of a person attempting to perform an action such as withdrawing money from a bank account, making a large purchase, or entering a country, permission to perform the action may be granted or denied. A level of confidence may be defined for each action. The identity of the person must be known to a confidence level that meets or exceeds the required level of confidence for the action to be approved. A foreign country may require different levels of confidence depending on the person's country of origin. A bank may require a higher level of confidence for larger transactions or frequent transactions.

In some cases, the party being asked to approve an action such as a border guard or bank employee may require a 3^{rd} party authority to attest as to the identity and authority of a person in order to increase their level of confidence to exceed the required level of confidence. Personal information may be gathered and classified as required or optional metadata and a hash or indicator based on this data may be communicated between devices to increase the level of confidence in a person's identity. Personal information may also be encrypted and stored directly on the blockchain. The data may be combined with a smart contract to provide multiple levels of access to those with authority or permission to view the data. For example, a border guard may be able to see complete passport data as well as a travel history. Other parties may only be able to see a public identity number.

An example of how a SSID can be derived from the hash of the entity's first public key is as follows:
Concrete identity=CID=H(p₀)

The concrete ID may be hashed with other factors to generate different IDs that can be used with different 3rd-party entities. In this way, the blockchain can store the relationship of a given device CID with its derivative IDs. Therefore, if the security of multiple 3rd-party entities is breached, there is no commonality in device identity between the different third parties, therefore increasing security of the overall system. Other factors used to produce the hash may include:
Insurance identity=IID=Insurance policy indicator.
Reliability=Rel=Percentage certainty.
List of fields=Dict{meta}=List of meta data available and verified.
Number of attestation=Num(attest)=total unique number of pointers.
Date ranges=Date(from, to)=Validity of information duration for insuring the interaction.
Recovery=Reco{social}=Pointers to other social identities
Role and access=Role(level)=level of access to metadata and the role defined.

A device may request that a second device perform an action. The second device may require the first device to provide a list of authorities which can attest as to the identity of the first device. The 2nd device may inspect the meta data provided by the authorities and develop a reliability as to the identity of the device. These interactions can be performed through smart contracts on the blockchain.

The blockchain is able to track the number of 3rd-party attestations for a given device. The attestation may apply for a specific duration of time after which the attestation is no longer valid. A device may provide a 2nd device access to its list of attestations through a smart contract on the blockchain.

A device may assign roles such as administrator and user to other devices. The role also includes a list of permissions that are allowed for each role. If the device is assigned the administrator role and it is subsequently lost, a recovery mechanism is required so that a new device can be assigned the administrator role. This mechanism could require the user of the new device to prove they are the administrator of the original device by relying on the attestation of their social network identities.

Access to metadata may be controlled by assigning a level of access to different roles.

The concrete identity, list of attestations, validity dates, meta data, reliability, roles and social identities can be associated with a plurality of OBD computers and mobile phones.
OBDC#1=VIN#, VSC#, H(p₀), IID, Rel, Dict{meta}, . . .
OBDC#2=VIN#, VSC#, H(p₀), IID, Rel, Dict{meta}, . . .
iPhone1=H(p₀), IID, Rel, Dict{meta}, Num(attest), Date(from, to), Reco{social}, Role(level)
iPhone2=H(p₀), IID, Rel, Dict{meta}, Num(attest), Date(from, to), Reco{social}, Role(level)
Android1=H(p₀), IID, Rel, Dict{meta}, Num(attest), Date(from, to), Reco{ social}, Role(level)

As the devices are used a sequence of events takes place which may be recorded and the events placed on the distributed ledger on the blockchain:
OBDC#1 is purchased: No information is on the device and the serial number of the device may be printed on the device in a QR code format.
OBDC#1 is powered on: VIN#, VSC#, H(p₀) is recorded by the system waiting for confirmation of ownership.
An app is installed on iPhone1: H(p₀), IID, Reco{social} is recorded.
The app scans the QR code on OBDC#1: H(p₀), IID, Reco{social}, Rel, Dict{meta} is recorded, and also Num(attest) increases by one. Date(from, to) will be for the duration of VSC. Role(level) will be Admin for first device and User for subsequent based on confirmation
OBDC#1 also gets new information calculated from VIN#, VSC#, H(p₀), IID, Rel, Dict{meta}, plus Date(from, to), Reco{ social}, and also Num(attest) increases by one.

Roles, such as administrator or user, may also be assigned to devices. For example
iPhone1=Admin(OBDC#1)
iPhone2=User(OBDC#1)
Android1=Admin(OBDC#2)

Embodiments of the invention can also be used to implement DRM (digital rights management) and supply chain management applications.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

What is claimed is:

1. A computing device comprising:
a processor module executing software to conduct a transaction;
a networking module enabling connections to a peer-to-peer network; and
an ASIC coupled to the processor module and the networking module, the ASIC comprising a blockchain server, an encryption module, and a memory storing a distributed ledger, the ASIC performing a calculation of a memory block within a predetermined minimum time and a predetermined maximum time, the block being stored in the distributed ledger by the blockchain server and transmitted to the peer-to-peer network by the networking module.

2. The computing device of claim 1 further comprising an OBD interface coupled to the processor module, the OBD interface coupled to a vehicle OBD bus and receiving operating information from the vehicle OBD bus.

3. The computing device of claim 1 wherein the ASIC further comprises a secure memory block, wherein the encryption module calculates a public key and a private key pair, the private key being stored in the secure memory block.

4. The computing device of claim 3 wherein the ASIC calculates a concrete identity of the computing device based on the public key and a unique value, the concrete identity being stored in the distributed ledger.

5. The computing device of claim 1 wherein a smart contract is stored in the distributed ledger, the smart contract comprising data and software to execute a peer-to-peer contract between the computing device and an external device, the computing device and the external device coupled through the networking module.

6. The computing device of claim 5 wherein the smart contract comprises identifying data of a user associated with the computing device and the software performs an authentication to allow a third person to access the identifying data.

7. The computing device of claim 1 wherein the calculation comprises generating a nonce, calculating a hash over the nonce and memory block data, and determining if the hash meets a requirement to be added to the blockchain.
